(19) United States
(12) Patent Application Publication
(10) Pub. No.: US 2016/0110775 A1
(43) Pub. Date: Apr. 21, 2016

(54) System and Method for Hash Desktop to Mobile Referral System

(71) Applicants: Ali Moiz, San Francisco, CA (US); Murtaza Hussain, San Francisco, CA (US)

(72) Inventors: Ali Moiz, San Francisco, CA (US); Murtaza Hussain, San Francisco, CA (US)

(21) Appl. No.: 14/515,507

(22) Filed: Oct. 15, 2014

(51) Int. Cl. G06Q 30/02

(52) U.S. Cl. CPC G06Q 30/0277

(57) ABSTRACT

A method and system of presenting advertisements for users of an online system across multiple devices and tracking user interactions with those advertisements through the use of hash values generates from the emails associated with the user account.

### FIELD OF INVENTION

The present invention generally relates to online advertising, and in particular to presenting advertisements for users of an online system across multiple devices and tracking user interactions with those advertisements.

### BACKGROUND

Various methods of marketing exist. Some traditional methods of marketing include word of mouth marketing, e-mail marketing such as using spam e-mails, and utilizing internet cookie technology to track an internet user accessing a particular website. However, these traditional methods of marketing may be of limited effectiveness. The merchandisers often spend a great deal of time and money advertising. However, as many merchandisers have discovered, trying to effectively advertise using conventional methods such as, for example, through television, newspaper, and Internet advertisements, is very expensive and not particularly effective.

In addition, many purchasers usually tend to shy away from these traditional marketing attempts or pitches. The conversion rate (i.e., the rate at which the targeted purchasers actually purchase the marketed products) may be very low while advertisers are under increasing pressure to lower the costs associated with marketing and to effectively and efficiently secure new customers. Furthermore, uninvited advertisements or ads such as email spam, pop-up ads and plug-in ads are being gradually phased out because of their unpopularity among users.

In addition, traditional methods of marketing may be generally ineffective with respect to tracking and awarding individuals responsible for referring others that actually purchase products that are marketed. Word of mouth and e-mail based marketing efforts may be ineffective because they lack a mechanism in place for identifying who forwarded a marketing e-mail or who passed on the “word of mouth.” In other words, it may be difficult to identify who passed on the marketing information that resulted in an actual purchase of marketed products.

However, advertisement revenue provides an important revenue stream for social networking systems, search engines, and other online systems. Therefore, various internet technology have been used to increase the likelihood of a user interacting with an advertisement, which provides revenue to the online system.

Most advertisers currently use some form of affiliate system to increase sales, track traffic using any of the known tracking mechanisms, for example, by using an unique identifier attached to the affiliate account provided by the merchant, and compensate referral sources for the traffic and/or transactions. Referral sources are generally the content providers of the Internet, who maintain URLs in order to disperse information and links to other URLs. These links are often in the form of a advertisement, such as a banner ad and/or text links. In these systems, the referral sources usually directs the traffic to the advertisers via predetermined selection and placement of Merchant's links. The referral sources are then generally compensated according to a given scale or interval, based on the sale.

The tracking mechanism allows the advertisers to apply commission and/or to credit clicks to the affiliate. Further, the tracking mechanism allows the referral sources to determine advertising compensation based on sale. Such a system, which relies on a unique id tracking mechanism, is commonly referred to as an affiliate program.

The growing popularity of affiliate programs among both content or service providers and advertiser has led to a wide array of resources addressing affiliate commerce. Such resources include search engines, directories, and compilations of referral provider feedback relating exclusively to affiliate program.

The affiliate receives an unique identifier from the affiliate program, and the affiliate uses that unique identifier as part of its linkage system (dynamic URL), to make the merchant site to track of who sent the traffic and/or transaction to apply the proper action such as a click or a sale commission.

All affiliate software use dynamic linkage or parameterized links where the unique identifier is attached to the end of the URL. The problem in those affiliate software is that Search Engines, and Google in particular. rank a page (in search results) based on how many outside pages are linking to that particular website/page. Affiliate programs seem to help because they link affiliate to web pages, but Search Engines have decided that links using dynamic parameters are in fact paid links and they are discarded from the links count.

Currently, online referral marketing generally tracks customer behavior online through the use of web browser cookies. These web browser cookies is a small piece of data that containers information about the user that is sent from a website and stored in a user's web browser while the user is browsing that website. Every time the user loads the website, the browser sends the cookie back to the sever to notify the website of the user's previous activity. Cookies were designed to be a reliable mechanism for websites to remember stateful information (such as items in a shopping cart) or to record the user's browsing activity (including clicking particular buttons, logging in, or recording which pages were visited by the user as far back as months or years ago).

Unfortunately, the use of cookies has drawbacks. For example, although cookies cannot carry viruses and cannot install malware on the host computer, tracking cookies and especially third-party tracking cookies are commonly used as ways to compile long-term records of individuals' browsing histories and behavior. cookies are used for tracking browsing behavior, they have recently been of great concern to Internet privacy advocates. As a result, cookies are a potential privacy concern that prompted European and U.S. law makers to take action. As such, many technology-savvy users are keen on minimizing the use of cookies.

In addition, cookies are also subject to a number of misconceptions, mostly based on the erroneous notion that they are computer programs. Even though cookies are simple pieces of data unable to perform any operation by themselves, they are often associated with malicious and undesirable code such as spyware, adware, viruses, and the like. As a result, cookies are frequently detected and removed, sometimes inadvertently, from computers by products designed to rid the computer of any perceived malicious or undesirable code.

Also, most modern browsers permit users to decide for themselves whether to accept cookies. Based on the erroneous belief that cookies are dangerous and therefore unwanted, customers sometimes manipulate their browser's settings to reject most or all cookies. By configuring their computer's settings in this manner, numerous websites become unusable. For example, shopping baskets implemented using cookies do not work if cookies are rejected.

Furthermore, users increasingly interact with content using multiple devices across different operating systems. For example, users frequently access a social networking system from desktop computers as well as smart phones or other mobile devices. Conventional techniques, such as cookie-based tracking systems, for advertisement selection do not account for a user's interactions across various devices. For example, user interactions with advertisements on a desktop computer are not used to select advertisements for presentation via a mobile device. This increases the likelihood that a user is shown duplicate advertisements across different devices, reducing the potential revenue to an online system providing advertisements. Similarly, the inability to identify the same user across devices makes it impossible to track impressions, conversions, and other user interactions with advertisements across devices.

Additionally, native applications on mobile devices do not maintain cookies or provide similar functionality for tracking and analyzing a user's activity on the mobile device. Even if a web browser on a mobile device maintains cookie tracking a user's browsing history, conventional native applications on the mobile device are unable to access these cookies, limiting the information available to the native applications for advertisement selection. This limits the ability of interactions with advertisements via native applications to be used in advertisement selection for the mobile device and for other devices with which a user interacts with content.

There exists, therefore, a need in the art for a cookie-less tracking system that operates without having to place cookies on a user computer and permits advertisers to better track a particular affiliate as the source of a referral with multiple devices across different operating systems. The invention provides such a tracking system without the use of cookies. These and other advantages of the invention, as well as additional inventive features, will be apparent from the description of the invention provided herein.

### OBJECTIVE OF THE INVENTION

Accordingly, it is the object of this invention to provide a system and method for tracking referrals from advertisements from computing device to mobile device.

It is also the object of the invention to provide a system and method for tracking referrals from advertisements across separate and multiple platforms and operating systems.

It is also the object of the invention to provide a system and method for tracking referrals from advertisements that is easy to implement, is cost-effective, and is efficient.

It is also the object of the invention to provide a system and method for tracking referrals from advertisements wherein the hash value is used as the identifying information.

It is also the object of the invention to provide a system and method for tracking referrals from advertisements wherein only the user's email is needed for use as an identification as it is the common link for accounts that are synced between various devices and operating systems.

It is also the object of the invention to provide a system and method for tracking referrals from advertisements wherein the email is ran into a hashing algorithm to yield a hash value, which is a unique hash string and can be used to match and track the referral.

It is also the object of the invention to provide a system and method for tracking referrals from advertisements wherein the advertisement or link from a computing device can refer the user to an application on a mobile device for installation on said mobile device.

It is also the object of the invention to provide a system and method for tracking referrals from advertisements wherein the email associated with the advertisement or link from the computing device will generate a unique hash string.

It is also the object of the invention to provide a system and method for tracking referrals from advertisements wherein the email associated with the account on the mobile device that installed the referred application will generate a unique hash string.

It is also the object of the invention to provide a system and method for tracking referrals from advertisements wherein an aggregator or attributor, which is a comparison engine, takes the hash value from both sides and compare for a match. If there is a match, the comparison engine indicates that a successful referral has occurred.

It is also the object of the invention to provide a system and method for tracking referrals from advertisements wherein it does not interfere with the experience of the user or require any input from the user.

It is also the object of the invention to provide a system and method for tracking referrals from advertisements without the use of the “cookies” information or data file.

It is also the object of the invention to provide a system and method for tracking referrals from advertisement wherein there is minimum security threat because hash value strings generated from emails cannot be reversed to recreate the emails. Therefore, even if a hash value string is leaked or stolen, it cannot be used to trace the user account or any of its associated user information or data.

### SUMMARY OF THE INVENTION

In one aspect of the invention, a system for tracking internet referral comprising: an user having a first email address and a second email address; a first platform in a computer comprising: an internet marketing link, a first hash module wherein the first hash module converts the first email address to a first email hash code after the user clicks the internet marketing link, a first transmission module wherein the first transmission module transmit the first email hash code to a comparison engine; a second platform comprising: a mobile application, a second hash module wherein the second hash module converts the second email address to a second email hash module code after the user login to the phone mobile application, a second transmission module wherein the second transmission module transmit the second email hash code to the comparison engine; the comparison engine determines success in referral by comparing the first email hash code to the second email hash code.

In one embodiment, the system wherein the first email address is same as the second email address.

In one embodiment, the system wherein the first email address is different as to the second email address wherein the user has a third email address wherein the first transmission module converts the third email address to a third email hash code and the first transmission module transmits the third email hash code to the comparison after the user clicks the internet marketing link and the second hash module convert the third email address to a fourth email hash code after the user login to the mobile application and the second transmission module transmits the fourth email has code to the comparison engine. In another embodiment, the system wherein the comparison engine determines success in referral by comparing the third email hash code to the fourth email hash code.

In one embodiment, the system wherein the first email address is different as to the second email address wherein the comparison engine has a database to match the first email hash code to the second email hash code.

In one embodiment, the system wherein the first hash module and the second hash module are MD5 Hash generator.

In one embodiment, the system wherein the first hash module and the second hash module are SHA1 Hash generator.

In one embodiment, the system wherein the first hash module and the second hash module use has generator selected from a group consisted of SHA0, SHA1, SHA3, SHA224, SHA256, SHA384, SHA512, MD2, MD4, MD5, Tiger, RipeMD and Panama.

In one embodiment, the system wherein the first email hash code is comprised of a time stamp code wherein the stamp code indicates the time when the user clicked the marketing link.

In one embodiment, the system wherein the first email hash code is comprised of a website code wherein the website code indicates the website where the user clicked the marketing link.

In one embodiment, the system wherein the first email hash code is comprised of a banner code wherein the website code indicates the identify of the marketing link.

In another aspect of the invention, a method for tracking internet referral comprising: providing an user; providing a marketing link; providing a first email address; providing a first email hash module; having the first email hash module to convert the first email address to a first hash module code after the user clicks the marketing link; transmitting the first hash module code to a comparison engine; providing a second email address; providing a second email hash module; providing a mobile application; converting the second email address to a second email hash code by the second hash module code after the user installs the mobile application; transmitting the second email hash code to the comparison engine; comparing the first email has code to the second email hash code track internet referral.

In one embodiment, the method wherein the first email address is same as the second email address.

In one embodiment, the method wherein the first email address is different as to the second email address wherein the user has a third email address wherein the first email hash module converts the third email address to a third email hash code and transmits the third email hash code to the comparison engine after the user clicks the internet marketing link and the second hash module convert the third email address to a fourth email hash code after the user installs the mobile application and transmits the fourth email has code to the comparison engine. In another embodiment, the method wherein the comparison engine determines referral by comparing the third email hash code to the fourth email hash code.

In one embodiment, the method wherein the first email address is different as to the second email address wherein the comparison engine has a database to match the first email hash code to the second email hash code.

In one embodiment, the method wherein the first hash module and the second hash module are MD5 Hash generator.

In one embodiment, the method wherein the first hash module and the second hash module are SHA1 Hash generator.

In one embodiment, the method wherein the first hash module and the second hash module use has generator selected from a group consisted of SHA0, SHA1, SHA3, SHA224, SHA256, SHA384, SHA512, MD2, MD4, MD5, Tiger, RipeMD and Panama.

In one embodiment, the method wherein the first email hash code is comprised of a time stamp code wherein the stamp code indicates the time when the user clicked the marketing link.

In one embodiment, the method wherein the first email hash code is comprised of a website code wherein the website code indicates the website where the user clicked the marketing link.

In one embodiment, the method wherein the first email hash code is comprised of a banner code wherein the website code indicates the identify of the marketing link.

### BRIEF DESCRIPTIONS OF THE DRAWINGS

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a schematic diagram illustrating an overall flowchart for the traditional method of tracking with the use of cookies.

FIG. 2 is a schematic diagram illustrating a flowchart showing the problem with using cookies for tracking across platforms from desktop to mobile through the Google Play store.

FIG. 3 is a schematic diagram illustrating a flowchart showing the use of emails or email hash values to track referrals across platforms from desktop to mobile through the Google Play store.

FIG. 4 is a schematic diagram illustrating a flowchart showing the backend process of the matching of the email hash value for tracking referrals across platforms from desktop to mobile.

FIG. 5 is a schematic diagram illustrating the avalanche effect of a small change in the input on the digest.

FIG. 6 is a schematic diagram illustrating the flowchart of a cryptographic hash function and its irreversibility.

FIG. 7 is a schematic diagram illustrating an overall flowchart for advertisers of the method and system of tracking advertisement referral through the use of hash values generated from the email associated with the user account.

FIG. 8 is a schematic diagram illustrating an alternative overall flowchart for advertiser of the method and system of tracking advertisement referral through the use of hash values generated from the email associated with the user account.

FIG. 9 is a schematic diagram illustrating an overall flowchart for developers of the method and system of tracking advertisement referral through the use of hash values generated from the email associated with the user account.

FIG. 10 is a schematic diagram illustrating an alternative aloverall flowchart for developers of the method and system of tracking advertisement referral through the use of hash values generated from the email associated with the user account.

### DETAILED DESCRIPTIONS OF THE INVENTION

The invention disclose herein provides for a system and method to allow an online system, such as a social networking system or a search engine system, to present advertisement to the user and to use emails or, preferably, email hash values to account for user interactions with advertisements received from multiple types of devices. While the invention can be practiced with the use of email, it would be a security risk and not recommended. As such, the disclosure of the invention herein will refer only to the use of email hash values in its discussion. Embodiments of the present disclosure allow for users to interact with advertisement from multiple types of devices, such as mobile devices and computer devices (e.g. desktop or laptop computers).

In the disclosure herein, traditional computing devices (“computing device” or “computing device”) refers to those devices running operating systems (“OS”) such Windows or Macintosh that traditionally relies on web browsers that uses cookies. on the other hand, mobile devices (“mobile device” or “mobile devices”) refers to those devices running operating systems such as Google Android or Apple iOS that are more commonly used for mobile phones, tablets, and wearable technology.

For example, in one embodiment, the system and method allow for the online system to present advertisement from a computing device to a mobile device, such as between a desktop computer and an Google Android-based mobile device. Therefore, when a user clicks on an advertisement on the desktop, the user is sent to the Google Play store listing for the specifically application presented in the advertisement. Then, the user clicks on the “Install” button and the application syncs to user's phone or tablet immediately through wi-fi or over-the-air va Google Play.

The problem with tracking the success rate of the number of application installation from the advertisement, however, is that Google Play Store on the desktop does not allow the referral application to pass from the desktop links to the mobile device. That is, Google Play only allows the flow from mobile-to-mobile. This is because in a computing device to computing device interaction, if a user interacts with an advertisement using a client application executing on a mobile device, the client application accesses a shared memory location of the mobile device to retrieve the user identification information. An application associated with the online system and executing on the mobile device stores the user identification information in the shared memory location, allowing other applications on the mobile device to retrieve the user identification information from the shared memory location.

Specifically, if a user interacts with an advertisement using a desktop computing device, a cookie is stored by the computing device including user identifying information and the advertisement. The online system accesses the cookie to identify the advertisement with which the user interacted and the user identifying information, and stores a description of the advertisement in a user profile associated with the user identifying information.

However, in a computing device to mobile device interaction, if a user interacts with an advertisement using a computing device, the application cannot be passed from the computing device to the mobile device for execution. This is because the computing device generally runs on a separate and different operating system as the mobile device, which generally runs on operating systems that do not accept or use cookies. Furthermore, the mobile device operating system generally does not allow the any application to pass from the computing device to the mobile device for execution.

The solution, therefore, is to use the user's account, which is the only common link between the computing device and the mobile device, to track the user's interaction. This is because the user's account is required for Google Play to sync to the mobile device. The user's account, or, more specifically, email, is, therefore, the only common identifier linking the same account on desktop and mobile device. Thus, using emails to attribute installs from desktop users will allow the referral application to identify and keep track of the user from desktop to mobile device. In particular, the email associated with the desktop device user is matched to the email associated with the mobile device user. If there is a match—if the emails are the same—then a successful referral has occurred. However, using emails for identifying and tracking referrals is a major security risk. Therefore, a method to protect the privacy users and their emails is to use a cryptographic function to generate email hash value. Specifically, using email with a cryptographic hash function protects the privacy of users and assists in attributing installs from desktop users. This further allows the referral application to identify and keep track of the user from desktop device to mobile device.

In particular, the user identification is hashed or otherwise encoded before being stored in the shared memory location. The client application then identifies the advertisement with which the user interacted to the online system along with the retrieved user identification information. Thus, advertisements with which the user interacted are identified by the user profile in the online system regardless of the device used to interact with the advertisement.

A hash function is any function that can be used to map digital data of arbitrary size to digital data of fixed size. Any slight variance in input data will produce a very big difference in output data—this is called the “avalanche effect,” where a small change will lead to a big difference. The value returned by a hash function are called hash values or simply hashes, which is a number generated from the string of text. Hash functions are useful in cryptography because it allows one to easily verity that some input data matches a stored hash value. Furthermore, hash functions are practically impossible to invert, that is, it is infeasible to recreate the input data from its hash value alone. The input data is also called the “message”, and the hash value generated from the message is called the “message digest” or “digest”.

Ideally, cryptographic hash function has four main properties. First, it should be easy to compute and generate the hash value for any given message. Second, it should be infeasible to generate a corresponding message with a given hash value. Third, it is infeasible to change a message without changing the hash value. Fourth, it is infeasible to find different messages with the same hash value.

Given that the hash value is substantially smaller than the text itself, and is generated by a formula in such a way that it is extremely unlikely that some other text will produce the same hash value, hash was originally used as a security feature, however, its now surprisingly ended up as a marketing tool that works across every marketing channel in use today.

Cryptographic hash functions also have many information security applications, notably, digital signatures, message authentication code (MACs), other forms of authentication, data indexing to detect duplication of data or uniquely identify files, etc. Of particular interest, hash has a cryptographic function where it is used to ensure that the transmitted messages have not been tampered. The sender generates a hash of the message, encrypts it, and sends it with the message itself. The recipient then decrypts both the message and the hash, produces another hash from the received message, and compares the two hashes. If they are the same, there is a very high probability that the message was transmitted in tact. If they are not the same, then the messages have been tampered with by a third party during transmission.

Hash is also a common method of accessing data records. For example, it takes an arbitrary piece of data, like an email address, and converts it to a 32-character hexadecimal string. Every time the same piece of data is run through the hashing algorithm, it will yield the same result. It should be noted that there are various standardized hashing functions or message digest algorithms other than MD5. Examples of such standardized hashing function includes SHA0, SHA1, SHA3, SHA224, SHA 256, SHA 384, SHA512, MD2, MD4, MD5, Tiger, RipeMD, Panama, etc. Therefore, using a different hashing function will produce a different hash value. The email address, which is a unique value, can be converted to a unique hash string through this process. For example, with MD5 as generator, “john@yahoo.com” has a value of “93dbc229b15534ce4e1eaf90ae618081”.

In the present invention, each time an advertisement link is clicked, an email associated with the user account is used to generate an unique hash value that is to be transmitted. Thereafter the user is sent to Google play-store to install an application associated with the advertisement. When the application is downloaded, installed, or opened, the same user's email address's hash value is also generated and transmitted. Because the user's emails were not transmitted, but rather, the hash values generated from the emails, the user's privacy was secured. Next, an aggregator or an attributor, which is a comparison engine, then takes the hash value from both sides and compare for a match. If there is a match, the comparison engine indicates that a successful referral has occurred.

There are a variety of methods to obtain the user email and to perform mobile attribution. In one embodiment, the publisher is a website with a login system. Therefore, the publisher would have the user's email address and can provide this information for tracking purposes. For privacy and security purposes, the publisher would generated the hash value from the emails and transmit the hash value to prevent the user emails from being leaked. Examples of such websites include Facebook, OKCupid, Reddit, etc.

In another embodiment, the publisher is a toolbar, browser plug-in, or other software product that is installed on the user's computer. This software product has the ability to execute the necessary tracking code to capture the user email addresses on the desktop in the browser. Again, the hash values for the user emails will be generated and then transmitted in order to protect the privacy and security of the users. Examples of such publishers are Mindspark, Spigot, Perion, or any other browser plug-in or toolbar.

In yet another embodiment, the publisher is a toolbar company on the desktop with large user base. The tracking code collects the user emails, generates the hash values from the emails, and saves the hash values into a cookie. Then, web publishers can work with advertisers in a traditional banner display model. The publisher's website inserts the Javascript Ad Tags, which have the ability to access the cookie that has the user information. When the user clicks on such an advertising, the hashed email is pass along for tracking purposes. The publishers' website does not need a login system nor need to transmit the emails directly. Example of such model includes CNN, Techcrunch, NYtimes, Youtube, etc.

The attribution can be done by the advertiser itself or it can be accomplished by a third party. For example, one such attribution application is the MobileAppTracking (MAT), which allows an advertiser to tracking its marketing campaigns across multiple advertising networks. By installing MAT's central tracking SDK, advertisers can collect identifiers from ad networks on click (or tap) and postback installs or other conversions to those advertising networks, reconciling reporting and managing campaigns from one place.

Kochava is another attribution and analytics platform that supports all major mobile formats including iOS, Android, Windows Phone, BlackBerry and Kindle. Kochava uses real-time attribution and analytics, along with the option of using a server-to-server application programming interface (API) for unlimited attribution if an software development kit (SDK) within the application, or in-app SDK, is not an option for the developer. Their SDK allows for integration straight out of the box so developers can get up and running quickly and easily. Furthermore, Kochava has a “RealTime Queuing technology,” which ensures that originating clicks are sent immediately to the application store so there isn't a delay in the user's overall experience. The technology also attributes the application launch and the install to the originating click for precision.

Referring back to the email john@yahoo.com, for example, if the user associated with this email account clicks on an advertisement or link on a webpage on his desktop, the email will be used to generate a unique hash value, which in this case is 93dbc229b15534ce4e1eaf90ae618081. This hash value will be transmitted to the aggregator or attributor. Thereafter, the user's mobile device will be directed to bring up an application associated with the advertisement. Upon downloading and installing the application, the user's email associate with the mobile device account will be used to generate the corresponding hash value. This hash value will also be transmitted to the attributor. Then, the attributor will compare the hash values from the computing device to the hash values from the mobile device to determine if there is a match. If there is a match, a successful referral has been made.

In particular, matching occurs when a first hash value generated from the email associated with the user's account matches the second hash value generated form the email associate with the user's account for downloading and installing the application. In one embodiment, there is a matching database in which the hash values are stored and used for matching. When a first hash value is generated, the aggregator compares that first hash value to the matching database containing hash value generated from the emails of users who have downloaded and installed the applications. The attributor compares the first hash value to the hash value in the database, and if the first hash value is the same as that of the hash value in the database, there is a match.

In another embodiment, a user may have multiple emails for multiple accounts, for instance, one email account for work and one email account for personal use. Attributor can associate these multiple email accounts belonging to the same user together. Thus, when the first hash value is generated with the user's email, the aggregator can compare that first hash value to all the hash values of the various emails associated with the same user. As such, if the first hash value is the same as the hash value of any of hash values generated from any of the emails associated with the user, then there is a match.

Specifically, the attributor then takes the hash value generated from the two email addresses and compare for a match. If the two hash values are identical, the comparison engine indicates that a successful referral has occurred. If the two hash values are not identical, then a referral was not successful and the advertisement source will not received credit for its referral.

In another embodiment, the hash value generated from the email associated with the user also includes a website identifier. This will further improve the accuracy of the matching algorithm to identify and track the referral source. This is because advertisers may place advertisements with multiple websites, and this complicates identifying and tracking the referral. Therefore, the website identifier will assist in identify the referral website and tracking the referral made, and therefore, will help determine the effectiveness of the advertisement with a particular website.

For example, the same advertisement for a particular product may be placed with both CNN.com and Foxnews.com. However, without identifying and tracking which website is the referral source, the advertiser would not know which website made more referrals, and, therefore, which website is better for advertising a particular product. Therefore, an website identifier “CNN” indicating CNN.com as the source of the referral is added to a hash value generated from the email associated with the account of the user. Also, an identifier “FOX” indicating Foxnews.com as the source of the referral is added to a hash value generated from the email associated with the account of the user. When there has been a click and the a corresponding application has been downloaded and installed, the attributor identifies, compares, and matches the two hash values, it will know that a successful referral has been made. Then, through the use of the website identifier in the hash value, either “CNN” of “FOX” in this example, the attributor will be able to identify the source of the referral. If the hash value contains the website identifier “CNN,” the attributor will be able to identify CNN.com as the referral source. If the hash value contains the website identifier “FOX,” the attributor will be able to identify Foxnews.com as the referral source. Therefore, this will allow the advertiser to better identify the referral website, and, therefore, better able to determine the effectiveness of an advertising with a particular website.

In another embodiment, each hash value generated from the email associated with user also includes an advertisement identifier. Frequently, advertisers will have multiple advertisements or advertisement campaigns to target different audiences. Being able to identify each advertisement or advertisement campaigns will allow the advertiser to identify which advertisement or advertisement campaigns made the referral, and therefore evaluate the effectiveness of each advertisement. For instance, there are often multiple, different advertisements for the same product. Each advertisement is used to target its audiences, and the advertiser wants to know which advertisement is more effective in getting a particular group of audiences to click on the advertisement.

In another embodiment, each advertisement may be a separate advertisement campaign intended to target a particular group of audiences. In which case, the advertiser can use the advertisement identifier to determine whether a particular campaign is working and, if so, if the campaign is effective in attracting its intended audiences.

For example, an advertiser for a particular game can create two different advertisements. One advertisement is geared towards males, and has an identifying value “BOY” identifying the type of advertisement or intended audiences for the game. Another advertisement is geared towards females, and has an identifying value “GIRL” identifying the type of advertisement or intended audiences for the game. The advertiser can place both type of advertisements with one website or with multiple websites. When there has been a click and the attributor matches and identifies the referral source, the identifying value of the advertisement will help the advertiser identify which advertisement worked more effectively. If the matching hash value contains the identifying value “BOY”, the advertiser would be able to determine that the advertisement intended to target male audiences made the referral. If the matching hash value contains the identifying value “GIRL”, the advertiser would be able to determine that the advertisement intended to target females made the referral. This will allow the advertiser to evaluate the effectiveness of its various advertisement campaigns in getting its targeted audiences to become a customer.

In another embodiment, each hash value generated from the email associated with the user also includes a time stamp identifier. This will allow the matching algorithm to more accurately identify and track the referral source. This is because there may be instances where there are multiple advertisement sources for the same product or application. In fact, it is not uncommon for an advertisement to be simultaneously displayed at multiple sources. In this case, if there are user clicks from different advertisement sources, a time stamp identifier is attached to the hash value indicating the source of advertisement providing the referral. For instance, if two advertisements both provides a link to the same Google Play store application, the time stamp identifier would indicate which advertisement made the referral. Specifically, the marker informs the publisher which advertisement the user clicked on that led to the installation of the application in the app store. In one embodiment, the two advertisements can be the same advertisement or different advertisements of the same product. In another embodiment, the two advertisements can also be on the same website or different websites.

In one embodiment, this can also be accomplished where the click closest in time to the installation of the application is credited with the referral. Therefore, if the user clicks on an advertisement on a website and then the users browses to another website and clicks on another advertisement that leads to the same application in the app store, the referral will be credited to the advertisement referral that is closest in time, which in this case is the advertisement from the second website.

For example, the aggregator matches and identifies that there are two referral, however, of the two referrals only one led to a click where a product was sold or a program was downloaded and installed. Furthermore, the hash value of the emails from the referrals are the same, therefore, the same user clicked on both links. While both referral sources made a referral and the same user click through, the advertiser needs to identify the referral source because it can only give credit to one referral source. In this instance, the aggregator would identifying the time that the product was sold or a program was installed in order to determine which advertisement made the referral that successfully led to the click-through.

In particular, if an advertisement for a particular product made a referral at 13:32:34 pm on Oct. 5, 2014 and a time stamp value of “13323410052014” is added to the hash value generated from the email of the user. Then, another advertisement also made a referral for the same product at 14:25:59 pm on Oct. 6, 2014 and a time stamp value of “14255910062014” is added to the hash value generated from the email of the user. If the purchase or installation of the program was made on at 14:45:35 pm on Oct. 6, 2014, the aggregator can identify the referral made on closest in time as the referral source, which is the referral made at 14:25:59 pm on Oct. 6, 2014 with a time stamp identifying value of “14255910062014”. This will allow the advertiser to more accurately identify and track its referrals, and, in turn, more accurately evaluate the effectiveness of its advertisements.

### DETAILED DESCRIPTIONS OF THE DRAWINGS

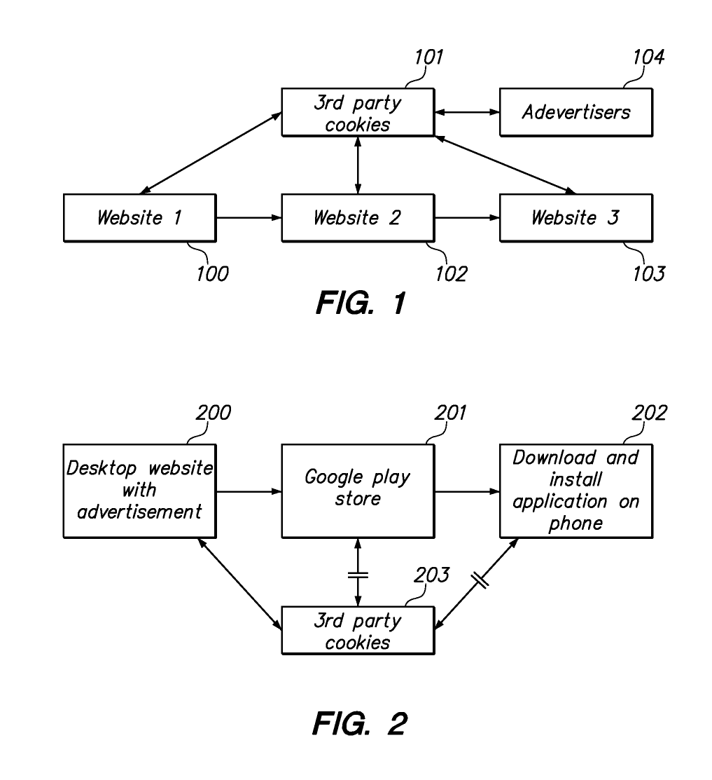

Referring to FIG. 1, this is a schematic diagram illustrating an overall flowchart for the traditional method of tracking with the use of cookies. As an example, when a user visits a website, website 1 100, the website contains an advertisement from a third party, which, when downloaded, sets a cookie 101 belonging to the advertisement's domain. Then, the user visits another website, website 2, 102, which also contains an advertisement from the same third party advertiser, and which also sets a cookie 100 belonging to that domain. Then, the user visits yet another website, website 3 103, which also contains an advertisement from the same third party advertiser, and which also sets a cookie 100 belonging to that domain. Eventually, all of these cookies will be sent to the advertiser 104 when loading their advertisements or visiting their websites. The advertiser can then use these cookies to build up a browsing history of the user across all the websites that have advertisements form this advertiser, allowing the advertiser to track the user.

Referring to FIG. 2, this is a schematic diagram illustrating a flowchart showing the problem with using cookies for tracking across platforms from desktop to mobile through the Google Play store. Unlike the traditionally method of tracking using cookies, mobile operating systems does not use cookies. Therefore, advertisers are unable to track users through multiple websites when the user is using multiple devices across platforms from desktop to mobile. For example, the use user is using a desktop website that contains a third party advertisement 200 and the user clicks on the advertisement 200, the user is taken to the Google Play store 201. Next, the user clicks on the application and downloads and installs the application on the user's phone 202. However, the third party's cookies 203 cannot be passed through to the Google Play store. Therefore, the cookies 203 are limited to what it can track, and it cannot track whether the user has downloaded or installed the application.

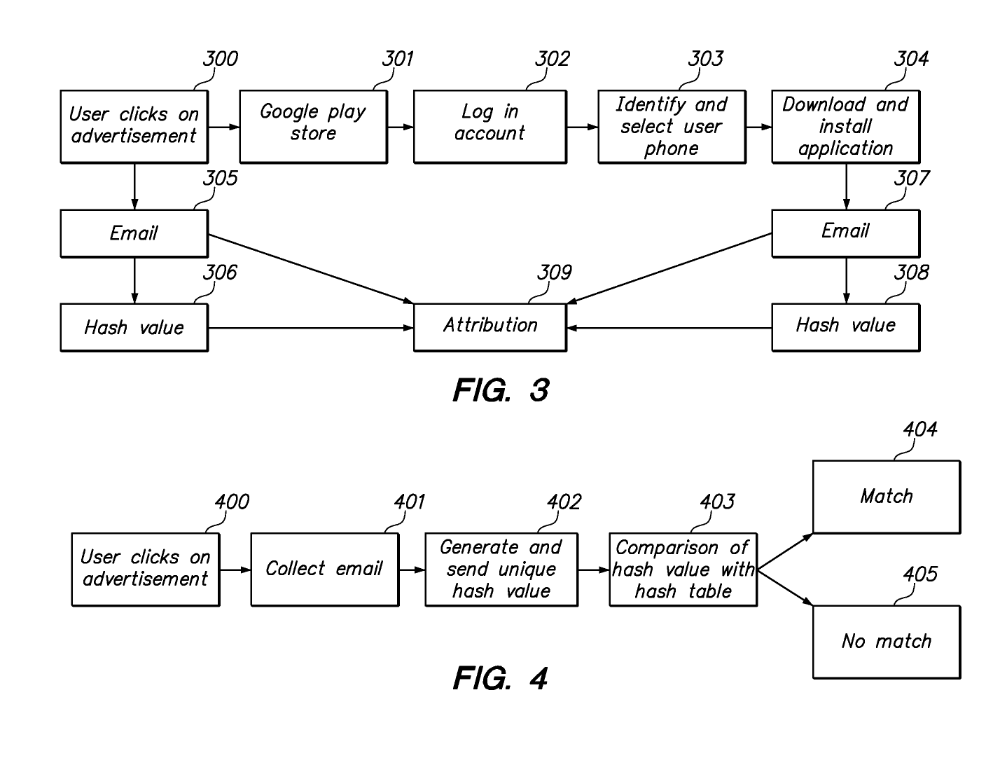

Referring to FIG. 3, this is a schematic diagram illustrating a flowchart showing the use of emails or email hash values to track referrals across platforms from desktop to mobile through the Google Play store. When a user clicks on an advertisement 300, the user is taken to the Google Play store 301 wherein the user would need to log in 302. Upon login, the user would could click on the application which would lead the Google Play store to identify and select the user's phone 303 for downloading and installation of the selected application 304. When the user clicks on an advertisement 300, the user's email 305 is obtained and the hash value 306 is generated from the email 305. When the user downloads and installs the application 304, the user's email 307 is obtained, and the hash value 308 is generated from the email 307. Finally, the two emails 305, 307 or, preferably for security reasons, the hash values 306, 308, are compared and matched through the use of attribution 309.

Referring to FIG. 4, this is a schematic diagram illustrating a flowchart showing the backend process of the matching of the email hash value for tracking referrals across platforms from desktop to mobile. When a user clicks on an advertisement 400, the user's email is collected 401. An unique hash value 402 is generated from a cryptographic hash function. Then, the hash value 402 is compared to a table or database of hash values generated from application installations. Therefore, if the hash value 402 generated from the click through on the advertisement is the same as one of the hash values in the database of hash values generated from application installations 403, there is a match 404. If the hash value 402 is not the same as any of hash values generated form application installations 403, there is no match 405.

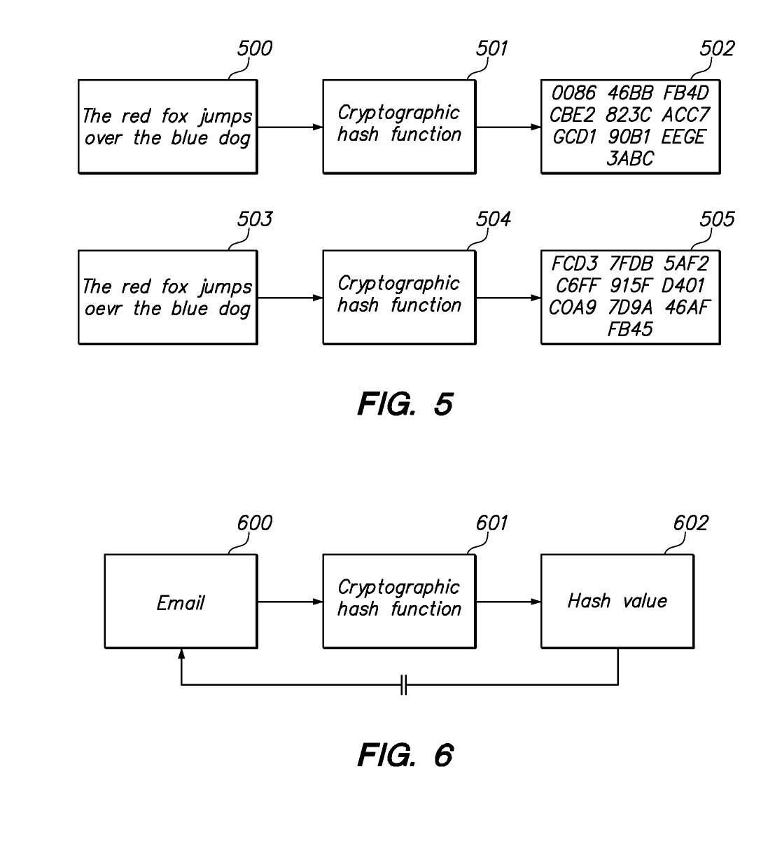

Referring to FIG. 5, this is a schematic diagram illustrating the avalanche effect of a small change in the input on the digest. The smallest changes in the text of the input can cause a large change in the digest. For example, when the input “The red fox jumps over the blue dog” 500 is run through a cryptographic hash function 501, it produces a hash value of “0086 46BB FB7D CBE2 823C ACC76CD1 90B1 EE6E 3ABC” 502. However, if the input is changed to “the red fox jumps oevr the blue dog” 503 and it is run through the cryptographic hash function 504, the hash value becomes completely different: “FCD3 7FDB 5AF2 C6FF 915F D401 C0A9 7D9A 46AF FB45” 505. A small change in the input results in a large change in the digest is referred to as the avalanche effect.

Referring to FIG. 6, this is a schematic diagram illustrating the flowchart of a cryptographic hash function and its irreversibility. When an email 600 is run through the cryptographic hash function 601, a unique hash value 602 is generated. The same hash value 602 will constantly be generated from the email 600 by the cryptographic hash function 601. This is a function that is practically impossible to invert. That is, it would be almost impossible to generate the email 600 from the corresponding hash value 602.

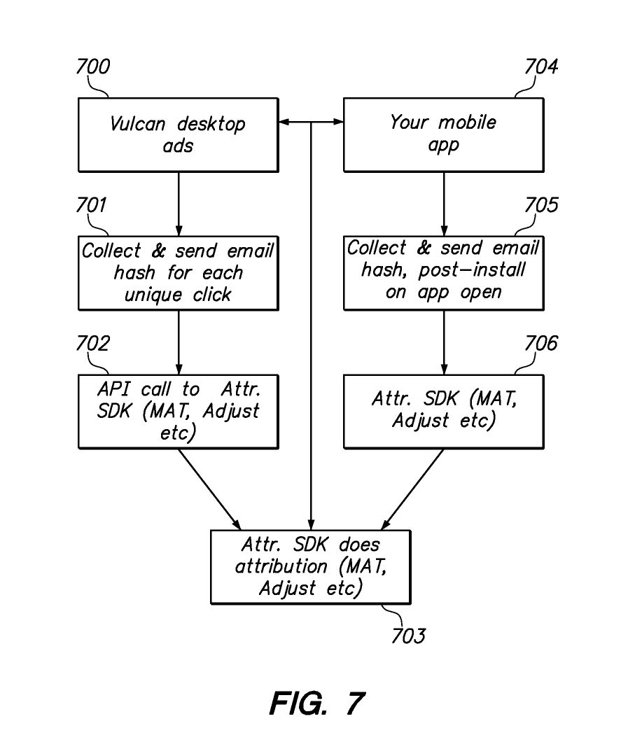

Referring to FIG. 7, this is an advertising network or a publisher 700, which provides page views to display advertising banner. Each time there is a click on the advertisement banner, the publisher 700 collects and sends an email hash 701 generated from the user's email. Then, the application programming interface (API) 702 calls to the attribution software development kit (SDK), wherein the email hash value 701 is transmitted to the comparison engine 703.

On the same figure, the advertiser 704, who in this case can be the mobile application developer, using its mobile application generates an email hash 705 once the app is installed or once every time the application is opened and the email hash is sent for attribution SDK 706. In one embodiment, the advertiser 700 can operate the comparison engine 703. In another embodiment, a third party attributor such as MAT, Adjust, or Kochava can operate the comparison engine 703 and provides the matching results to the advertiser who was contracted by the advertiser to perform attribution measurement services. The comparison engine 703 does the attribution and then reports back to the advertising network or publisher 700 and the advertiser 704 via its mobile application.

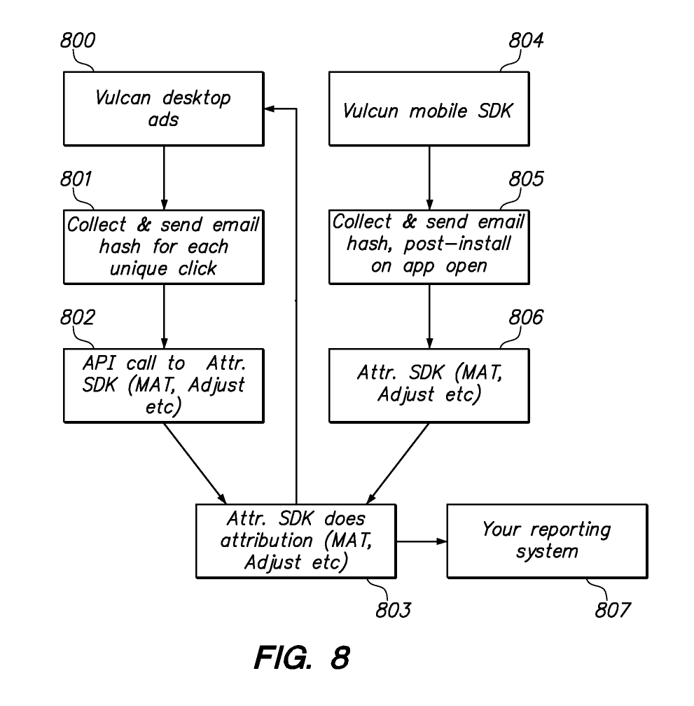

Referring to FIG. 8, this is an advertising network or publisher 800, which provides page views to display advertising banner. Each time there is a click on the advertisement banner, the advertising network collects and sends an email hash 801. Then, the application programming interface (API) 802 calls to the attribution software development kit (SDK), wherein the email hash value 801 is transmitted to the comparison engine 803.

On the same figure, the advertising network 804 provides a SDK for the developer who in this case is the advertiser where the SDK is adopted such that the mobile application developer generates a email hash 805 once the app is installed or once each time the application is opened and the email hash is also sent to the attribution SDK 806. In one embodiment, the advertiser 800 can operate the comparison engine 803. In another embodiment, a third party attributor such as MAT, Adjust or Kochava can operate the comparison engine 803 and provide the matching results to the advertiser who was contracted by the advertiser to perform attribution measurement services. The comparison engine 803 does the attribution and then reports back to the advertising network or publisher 800 and to the advertiser 704 via its own reporting system 807.

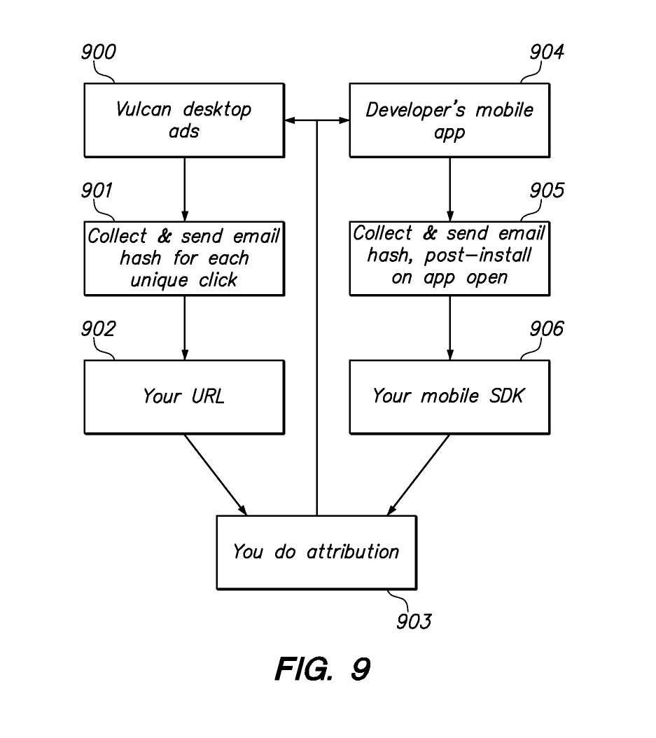

Referring to FIG. 9, this is an advertising network or a publisher 900, which provides page views to display advertising banner. Each time there is a click on the advertising banner, the publisher 900 collects and sends an email hash 901. Then, the application programming interface (API) 902 allows the publisher to use its own URL 902, wherein the email hash value 901 is transmitted to the publisher's own comparison engine 903.

On the same figure, the advertiser 904, who in this case can be the mobile application developer, generates a email hash 905 once the app is installed or once every time the application is opened and the email hash 905 is also sent to developer's mobile SDK 906, wherein the email hash value 901 is transmitted to the publisher's own the comparison engine 903. In this embodiment, the advertiser 900 operates the comparison engine 903 where the comparison engine provides the matching result to the advertiser 900 who perform its own attribution measurement services. The comparison engine 903 does the attribution and then reports back to the advertising network or publisher 900 and to the advertiser 904.

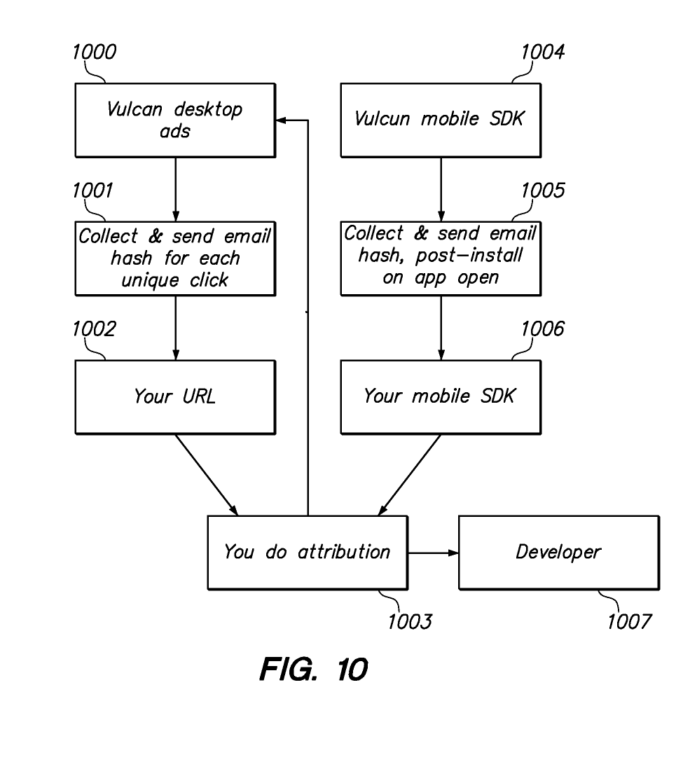

Referring to FIG. 10, this is an advertising network or a publisher 1000, which provides page views to display advertising banner. Each time there is a click on the advertising banner, the publisher 1000 collects and sends an email hash 1001. Then, the application programming interface (API) 1002 allows the publisher to use its own URL 1002, wherein the email hash value 1001 is transmitted to the publisher's own comparison engine 1003.

On the same figure, the advertiser 1004, who in this case can be the mobile application developer, generates a email hash 1005 once the app is installed or once every time the application is opened and the email hash 1005 is also sent to developer's mobile SDK 1006, wherein the email hash value 1001 is transmitted to the publisher's own the comparison engine 1003. In this embodiment, the advertiser 1000 operates the comparison engine 1003 where the comparison engine provides the matching result to the advertiser 1000 who perform its own attribution measurement services. The comparison engine 1003 does the attribution and then reports back to the advertising network or publisher 1000 and to the advertiser 1004.

1. a system for tracking internet referral comprising:
a. an user having a first email address and a second email address;
b. a first platform in a computer comprising:
i. an internet marketing link;
ii. a first hash module wherein said first hash module converts said first email address to a first email hash code after said user clicks said internet marketing link
iii. a first transmission module wherein said first transmission module transmit said first email hash code to a comparison engine;
c. a second platform comprising:
i. a mobile application;
ii. a second hash module wherein said second hash module converts said second email address to a second email hash module code after said user login to said phone mobile application;
iii. a second transmission module wherein said second transmission module transmit said second email hash code to said comparison engine;
d. said comparison engine determines success in referral by comparing said first email hash code to said second email hash code.

2. The system of claim 1 wherein said first email address is same as said second email address.

3. The system of claim 1 wherein said first email address is different as to said second email address wherein said user has a third email address wherein said first transmission module converts said third email address to a third email hash code and said first transmission module transmits said third email hash code to said comparison after said user clicks said internet marketing link and said second hash module convert said third email address to a fourth email hash code after said user login to said mobile application and said second transmission module transmits said fourth email has code to said comparison engine.

4. The system claim of 3 wherein said comparison engine determines success in referral by comparing said third email hash code to said fourth email hash code.

5. The system of claim 1 wherein said first email address is different as to said second email address wherein said comparison engine has a database to match said first email hash code to said second email hash code.

6. The system of claim 1 wherein said first hash module and said second hash module are MD5 Hash generator.

7. The system of claim 1 wherein said first hash module and said second hash module are SHA1 Hash generator.

8. The system of claim 1 wherein said first hash module and said second hash module use has generator selected from a group consisted of SHA0, SHA1, SHA3, SHA224, SHA256, SHA384, SHA512, MD2, MD4, MD5, Tiger, RipeMD and Panama.

9. The system of claim 1 wherein said first email hash code is comprised of a time stamp code wherein said stamp code indicates the time when said user clicked said marketing link.

10. The system of claim 1 wherein said first email hash code is comprised of a website code wherein said website code indicates the website where said user clicked said marketing link.

11. The system of claim 1 wherein said first email hash code is comprised of a banner code wherein said website code indicates the identify of said marketing link.

12. A method for tracking internet referral comprising:
a. providing an user;
b. providing a marketing link;
c. providing a first email address;
d. providing a first email hash module;
e. having said first email hash module to convert said first email address to a first hash module code after said user clicks said marketing link;
f. transmitting said first hash module code to a comparison engine;
g. providing a second email address;
h. providing a second email hash module;
i. providing a mobile application;
j. converting said second email address to a second email hash code by said second hash module code after said user installs said mobile application;
k. transmitting said second email hash code to said comparison engine;
l. comparing said first email has code to said second email hash code track internet referral.

13. The method of claim 12 wherein said first email address is same as said second email address.

14. The method of claim 12 wherein said first email address is different as to said second email address wherein said user has a third email address wherein said first email hash module converts said third email address to a third email hash code and transmits said third email hash code to said comparison engine after said user clicks said internet marketing link and said second hash module convert said third email address to a fourth email hash code after said user installs said mobile application and transmits said fourth email has code to said comparison engine.

15. The method of claim of 14 wherein said comparison engine determines referral by comparing said third email hash code to said fourth email hash code.

16. The method of claim 12 wherein said first email address is different as to said second email address wherein said comparison engine has a database to match said first email hash code to said second email hash code.

17. The method of claim 12 wherein said first hash module and said second hash module are MD5 Hash generator.

18. The method of claim 21 wherein said first hash module and said second hash module are SHA1 Hash generator.

19. The method of claim 12 wherein said first hash module and said second hash module use has generator selected from a group consisted of SHA0, SHA1, SHA3, SHA224, SHA256, SHA384, SHA512, MD2, MD4, MD5, Tiger, RipeMD and Panama.

20. The method of claim 12 wherein said first email hash code is comprised of a time stamp code wherein said stamp code indicates the time when said user clicked said marketing link.

21. The method of claim 12 wherein said first email hash code is comprised of a website code wherein said website code indicates the website where said user clicked said marketing link.

22. The method of claim 12 wherein said first email hash code is comprised of a banner code wherein said website code indicates the identify of said marketing link.
